(19) United States
(12) Patent Application Publication
(10) Pub. No.: US 2025/0267444 A1
(43) Pub. Date: Aug. 21, 2025

(54) USER EQUIPMENT, NETWORK NODES, AND METHODS PERFORMED IN A COMMUNICATION NETWORK

(71) Applicant: Telefonaktiebolaget LM Ericsson (publ), Stockholm (SE)

(72) Inventors: Pradeepa RAMACHANDRA, Linköping (SE); Marco BELLESCHI, Solna (SE)

(21) Appl. No.: 18/573,100

(22) PCT Filed: Jun. 22, 2022
(86) PCT No.: PCT/SE2022/050621

§ 371 Date: Dec. 21, 2023

Related U.S. Application Data
(60) Provisional application No. 63/214,278, filed on Jun. 24, 2021.

(51) Int. Cl. H04W 8/08

(52) U.S. Cl. CPC H04W 8/08

(57) ABSTRACT

Embodiments herein relate to, for example, a method performed by a UE for handling communication in a wireless communication network. The UE indicates to a first network node or a second network node, a capability of reporting a first stored information associated with one or more secondary nodes and secondary cells. The UE further receives a second indication from the first network node or the second network node, indicating a request to fetch the first stored information associated with the one or more secondary nodes and secondary cells. The UE transmits an indication of the first stored information, or the first stored information.

### TECHNICAL FIELD

Embodiments herein relate to a user equipment (UE), a first and a second network node, and methods performed therein regarding communication in a wireless communication network. Furthermore, a computer program product and a computer-readable storage medium are also provided herein. Especially, embodiments herein relate to handling communication, e.g., handling reporting from the UE in the wireless communication network.

### BACKGROUND

In a typical wireless communication network, UEs, also known as wireless communication devices, mobile stations, stations (STA) and/or wireless devices, communicate via a Radio Access Network (RAN) to one or more core networks (CN). The RAN covers a geographical area which is divided into service areas or cells, with each service area or cell being served by a network node such as an access node, e.g., a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the network node. The network node operates on radio frequencies to communicate over an air interface with the UEs within range of the access node. The network node communicates over a downlink (DL) to the UE and the UE communicates over an uplink (UL) to the network node. The network node may be a distributed node comprising a remote radio unit and a separated baseband unit.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with UEs. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several network nodes may be connected, e.g., by landlines or microwave, to a controller node, such as a radio network controller (RNC) or a base station controller (BSC), which supervises and coordinates various activities of the plural network nodes connected thereto. The RNCs are typically connected to one or more core networks.

Specifications for the Evolved Packet System (EPS) have been completed within the 3^{rd} Generation Partnership Project (3GPP) and this work continues in the coming 3GPP releases, such as for 5G and next generation networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the network nodes are directly connected to the EPC core network. As such, the RAN of an EPS has an essentially “flat” architecture comprising network nodes connected directly to one or more core networks.

With the emerging 5G technologies also known as new radio (NR), the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions. 5G is the fifth generation of cellular technology and was introduced in Release 15 of the 3GPP standard. It is designed to increase speed, reduce latency, and improve flexibility of wireless services. The 5G system (5GS) includes both a new radio access network (NG-RAN) and a new core network (5GC).

Mobility history information (MHI) has been introduced in LTE and has been adopted in NR as well. The MHI measurements are accumulated by the UE independent of its radio resource control (RRC) state, such as Idle/Inactive/Connected state. As part of the MHI, the UE stores the cell identifier which is the current serving cell for this UE and also stores the information related to how long the UE has stayed in this cell. The UE further keeps such a history for up to past 16 serving cells. The UE also includes information related to how long it has been out of coverage as well.

The procedural text related to the UE's accumulation of the MHI information in LTE is shown in section 5.6.11 of Technical Specification (TS) 36.331 v.16.4.0 and the corresponding ASN.1 can be found in the information element (IE) VisitedCellInfoList in section 6.3.6 of TS 36.331. This MHI, hereby referred to as LTE-MHI, is covering only visited LTE cells.

Similarly, the procedural text related to the UE's accumulation of the MHI information in NR is shown in section 5.7.9 of TS 38.331 and the corresponding ASN.1 can be found in the IE VisitedCellInfoList in section 6.3.4 of TS 38.331. This MHI, hereby referred to as NR-LTE-MHI, is covering both visited LTE cells and visited NR cells.

The UE can indicate the availability of this mobility history via the field mobilityHistoryAvail in either RRCSetupComplete or RRCResumeComplete messages. It is the RAT of the fetching cell that implicitly decides whether the UE will report the LTE-MHI or the NR-LTE MHI.

Based on the MHI reported by the UE, the network can estimate the UE mobility characteristics such as UE speed.

The network can also propagate the received MHI between network nodes upon handover of the UE. Currently, the specification TS 38.423 only covers propagation of NR-LTE-MHI, but also propagation of NR-MHI is being discussed in standardization, see for example R3-211697.

### Random Access (RA) Enhancements

### RA Optimization

The random access channel (RACH) configuration has critical impacts on user experience and overall network performance. The RACH collision probability, and therefore access setup delays, data resuming delays from the UL unsynchronized state, handover delays, transition delays from RRC_INACTIVE, and beam failure recovery delays are all affected by the RACH settings. In addition, performing RACH on the most suitable DL beam is also important and will avoid unnecessary power ramping and failed RACH attempts. This is beneficial both for the network as well as for the attempting device; it allows to avoid unnecessary interference in the network and, also, reduces the experienced delay and UE energy consumption. In NR, a new feature allows a UE to change RACH resource during a RACH procedure, which may lead to more complex behaviour.

The setting of RACH parameters depends on a multitude of factors, e.g.:
the uplink inter-cell interference from the Physical Uplink Shared Channel (PUSCH),
RACH load; call arrival rate, handover (HO) rate, tracking area update, RRC_Inactive transition rate, the request for other system information (SI), the beam failure recovery, traffic pattern and population under the cell coverage as it affects the UL synchronization states and hence the need to use random access,
UL and supplementary uplink (SUL) imbalances,
PUSCH load,
the cubic metric of the preambles allocated to a cell,
whether the cell is in high-speed mode or not,
UL and DL imbalances.

The targets of RACH optimization are indicated as follows:
Minimize access delays for the UEs under the coverage of popular synchronization signal blocks (SSB).
Minimize the delays for the UEs to request the other SIs.
Minimize the imbalance of UEs access delays on UL and SUL channel.
Minimize the beam failure recovery delays for the UEs in RRC_Connected.
Minimize the failed/unnecessary RACH attempts on RACH resource before success.

Consequently, the RACH optimization function will attempt to automatically set several parameters related to the performance of RACH.

Automatic RACH parameter settings can be enabled by collecting the RACH report from the UE and by Physical Random Access Channel (PRACH) parameters exchange between gNBs. The mechanism and content of information report/exchange for RACH optimization in LTE could be the baseline whereas taking NR new features. e.g., beam, SUL, etc. into account.

The setting of RACH parameters that can be optimized are:
RACH configuration (resource unit allocation);
RACH preamble split (among dedicated, group A, group B);
RACH backoff parameter value;
RACH transmission power control parameters.

As a minimum, RACH optimization is realized by UE providing RACH related information report to the NG RAN node, and by exchange of PRACH configuration of normal UL carrier and SUL carrier between NG RAN node.

For central unit (CU)-distributed unit (DU) architecture, gNB-DU should be allowed to report its RACH configuration per cell to the gNB-CU, and the gNB-CU should be allowed to signal the RACH configuration per served cell to neighbouring NG RAN nodes. This allows NG-RAN nodes to identify whether RACH configurations of neighbouring cells are optimized or whether changes are needed in order to achieve a better RACH coordination between neighbouring cells.

Upon receiving the polling message requesting RACH report, e.g., UE Information Request message, from the NG RAN node, potentially gNB-CU of the current serving cell, UE reports RACH information within a UE Information Response message. The gNB-CU and gNB-DU take into account the RACH report and other node information, to achieve an optimized RACH configuration.

The contents of the RACH information report may comprise one or more of the following:
Indices of the SSBs and number of RACH preambles sent on each tried SSB listed in chronological order of attempts.
The frequency, NR absolute radio-frequency channel number (ARFCN), of tried SSBs.
The beam quality of each tried SSB, i.e., beam level measurement during RACH attempts such as beam reference signal received power (BRSRP), beam reference signal received quality (BRSRQ), beam signal to interference plus noise ratio (BSINR)
Indication whether the selected SSB is above or below the rsrp-ThresholdSSB threshold.
Elapsed time from the last measurement prior to the beam selection time
Number of RACH preambles sent on SUL
Number of RACH preambles sent on normal UL (NUL)
Total number of fallbacks between Contention Based RACH Access (CBRA) and Contention Free RACH Access (CFRA) Contention detection indication

The above RACH information report may also be applied to the secondary node (SN) for MR-DC case

The report of RACH information when a random access procedure is performed may be requested by the network via the UE Information procedure in RRC, section 5.7.10.3 of TS 38.331 v 16.4.1, in the case where a RACH procedure was successful. Further, what information is included by the UE in the RA report is specified in section 5.7.10.5 of TS 38.331 v 16.4.1.

Abstract Syntax Notation (ASN; ASN1; ASN.1) used herein, e.g. as code snippets, describes what information is/may be communicated in each referenced scenario. RAN3 has already agreed that secondary cell group (SCG) related RA information is useful in optimizing the RA parameters of the SCG related cells. RAN3 has sent to RAN2 information on the same topic in R2-2008723. RAN2 is also discussing the storage of the SN related MHI by the UE and it is already agreed that the UE can store primary secondary cell (PSCell) ID and the time to stay in the PSCell, see below agreement related to R2-2008723 regarding mobility history information enhancements:
If PSCell MHI is introduced, include at least PSCell ID into PSCell MHI. One may further include cell global identity (CGI) or frequency+physical cell ID (PCI), and the time UE stayed in each PSCell into PSCell MHI.

### SUMMARY

As part of developing embodiments herein one or more problems have been identified. Though the above agreements indicate that the UE should store the SCG related RA information and the MHI information, there has been no agreements on how the fetching of these information works i.e., is it just the MN who can fetch these UE stored measurements or is it just the SN or can any of them fetch this information? During RAN2 #113-bis meeting, companies discussed different options related to how the SN related RA report can be fetched from the UE, details in R2-2104536, and most companies preferred the option of MN fetching the RA report from the UE.

In R2-2104536 it is proposed as Proposal 11 that a UE reports the SN RACH report to the MN, and then MN sends the SN RACH report to the SN. It is furthermore proposed that RAN2 should discuss and reply a Liaison statement (LS) to R2-2008723.

An object of embodiments herein is to provide a mechanism that handles communication in the wireless communication network in an efficient and improved manner.

According to an aspect the object is achieved by providing a method performed by a first network node for handling communication in a wireless communication network. The first network node receives a capability indication that a UE is capable of reporting a first stored information associated with one or more secondary node and/or secondary cells. The first network node transmits to the UE, a second indication indicating a request to fetch the first stored information associated with the one or more secondary nodes and/or secondary cells. The first network node may receive from a UE, a first indication that the UE has available first stored information associated with one or more secondary node and/or secondary cells; or receive a request from a second network node to retrieve or fetch the available first stored information.

According to another aspect the object is achieved by providing a method performed by a UE for handling communication in a wireless communication network. The UE indicates to a first network node or a second network node, a capability of reporting a first stored information associated with one or more secondary nodes and/or secondary cells. The UE receives a second indication from the first network node or the second network node, indicating a request to fetch the first stored information associated with the one or more secondary nodes and/or secondary cells. The UE then transmits an indication of the first stored information, or the first stored information. The indication or the first stored information may be transmitted to the first network node or the second network node. The user equipment may transmit a first indication that the UE has available first stored information associated with the one or more secondary node and/or secondary cells. This first indication may be transmitted to the first network node or the second network node.

According to yet another aspect the object is achieved by providing a method performed by a second network node for handling communication in a wireless communication network. The second network node receives from a first network node or a UE, a capability indication that the UE is capable of reporting a first stored information associated with one or more secondary nodes and/or secondary cells. The second network node then transmits a second indication to the UE or to the first network node, indicating a request to fetch the first stored information associated with the one or more secondary nodes and/or secondary cells. The second network node may receive, from the UE or from the first network node, a first indication that the UE has available first stored information associated with the one or more secondary node and/or secondary cells. The first indication may indicate presence or availability of mobility history information at the UE e.g. availability of a report of mobility history information of SN or PSCell(s).

It is furthermore provided herein a computer program product comprising instructions, which, when executed on at least one processor, cause the at least one processor to carry out any of the methods herein, as performed by the first, second network node, and the UE, respectively. It is additionally provided herein a computer-readable storage medium, having stored thereon a computer program product comprising instructions which, when executed on at least one processor, cause the at least one processor to carry out the methods herein, as performed by the first network node, the second network node, and the UE, respectively.

According to an aspect the object is achieved, according to embodiments herein, by providing a first network node, a second network node, and a UE configured to perform the methods herein, respectively.

Thus, it is herein provided a first network node for handling communication in a wireless communication network. The first network node is configured to receive a capability indication that a UE is capable of reporting a first stored information associated with one or more secondary node and/or secondary cells. The first network node is further configured to transmit to the UE, a second indication indicating a request to fetch the first stored information associated with the one or more secondary nodes and/or secondary cells.

Furthermore, it is herein provided a UE for handling communication in a wireless communication network. The UE is configured to indicate to a first network node or a second network node, a capability of reporting a first stored information associated with one or more secondary nodes and/or secondary cells. The UE is configured to receive a second indication from the first network node or the second network node, indicating a request to fetch the first stored information associated with the one or more secondary nodes and/or secondary cells. The UE is further configured to transmit an indication of the first stored information, or the first stored information

In addition, it is herein provided a second network node for handling communication in a wireless communication network. The second network node is configured to receive from a first network node or a UE, a capability indication that the UE is capable of reporting a first stored information associated with one or more secondary nodes and/or secondary cells. The second network node is further configured to transmit a second indication to the UE or to the first network node, indicating a request to fetch the first stored information associated with the one or more secondary nodes and/or secondary cells.

Embodiments herein disclose a solution enabling network nodes to fetch first stored information, such as MHI, associated with one or more secondary nodes and/or secondary cells in an efficient and improved manner by using the capability indication to trigger the fetching of the first stored information.

### BRIEF DESCRIPTION OF THE DRAWINGS

Embodiments will now be described in more detail in relation to the enclosed drawings, in which:

FIG. 1 is a schematic overview depicting a wireless communication network according to embodiments herein;

FIG. 2 is a schematic combined flowchart and signalling scheme according to some embodiments herein;

FIG. 3 is a schematic combined flowchart and signalling scheme according to some embodiments herein;

FIG. 4 is a schematic flowchart depicting a method performed by a user equipment according to some embodiments herein;

FIG. 5 is a schematic flowchart depicting a method performed by a first network node according to some embodiments herein;

FIG. 6 is a schematic flowchart depicting a method performed by a second network node according to some embodiments herein;

FIG. 7 is a block diagram depicting UEs according to some embodiments herein;

FIG. 8 is a block diagram depicting first network nodes according to some embodiments herein;

FIG. 9 is a block diagram depicting second network nodes according to some embodiments herein;

FIG. 10 schematically illustrates a telecommunication network connected via an intermediate network to a host computer;

FIG. 11 is a generalized block diagram of a host computer communicating via a base station with a user equipment over a partially wireless connection; and

FIGS. 12-15 are flowcharts illustrating methods implemented in a communication system including a host computer, a base station and a user equipment.

### DETAILED DESCRIPTION

Embodiments herein are described in the context of 5G/NR but the same concept may also be applied to other wireless communication systems. Embodiments herein may be described within the context of 3GPP NR radio technology (3GPP TS 38.300 V15.2.0 (2018-06)), e.g., using gNB as the network node. It is understood, that the problems and solutions described herein are equally applicable to wireless access networks and UEs implementing other access technologies and standards. NR is used as an example technology. Using NR in the description is particularly useful for understanding the problem and solutions solving the problem. However, embodiments are applicable also to 3GPP LTE, or 3GPP LTE and NR integration, also denoted as non-standalone NR.

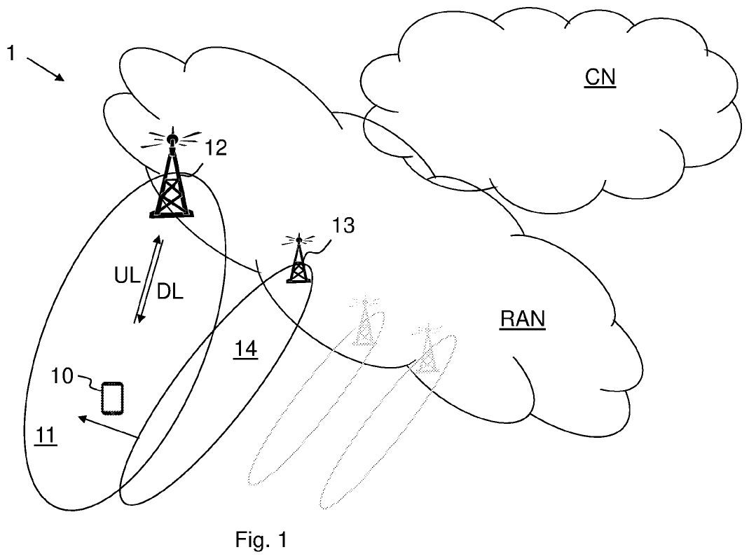

Embodiments herein relate to wireless communication networks in general. FIG. 1 is a schematic overview depicting a wireless communication network 1. The wireless communication network 1 comprises e.g. one or more RANs and one or more CNs. The wireless communication network 1 may use one or a number of different technologies, such as Wi-Fi, LTE, LTE-Advanced, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in 5G systems, however, embodiments are also applicable in further development of the existing communication systems such as e.g. WCDMA or LTE.

In the wireless communication network 1, wireless devices e.g. a UE 10 such as a mobile station, a non-access point (non-AP) station (STA), a STA, a user equipment and/or a wireless terminal, communicate via one or more Access Networks (AN), e.g. RAN, to one or more CNs. It should be understood by the skilled in the art that “UE” is a non-limiting term which means any terminal, wireless communication terminal, user equipment, Machine Type Communication (MTC) device, Device to Device (D2D) terminal, internet of things (IoT) operable device, or node e.g. smart phone, laptop, mobile phone, sensor, relay, mobile tablets or even a small base station capable of communicating using radio communication with a network node within an area served by the network node.

The communication network 1 comprises a first network node 12 providing e.g. radio coverage over a geographical area, a first service area 11 i.e. a first cell, of a RAT, such as NR, LTE, Wi-Fi, WiMAX or similar. The first network node 12 may be a transmission and reception point, a computational server, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used. The first network node 12 may alternatively or additionally be a controller node or a packet processing node or similar. The first network node 12 may be referred to as source access node or a serving network node wherein the first service area 11 may be referred to as a serving cell, source cell or primary cell, and the first network node communicates with the UE 10 in form of DL transmissions to the UE 10 and UL transmissions from the UE 10. The first network node may be a distributed node comprising a baseband unit and one or more remote radio units. The first network node 12 is herein exemplified as a current or last serving network node also denoted as a master node (MN).

The communication network 1 comprises a second network node 13 providing e.g. radio coverage over the geographical area, a second service area 14 i.e. a second cell, of a RAT, such as NR, LTE, Wi-Fi, WiMAX or similar. The second network node 13 may be a transmission and reception point, a computational server, a base station e.g. a network node such as a satellite, a WLAN access point or an AP STA, an access node, an access controller, a radio base station such as a NodeB, an eNB, eNodeB, a gNB, a base transceiver station, a baseband unit, an Access Point Base Station, a base station router, a transmission arrangement of a radio base station, a stand-alone access point or any other network unit or node depending e.g. on the radio access technology and terminology used. The second network node 13 is herein exemplified as a current or a previously serving secondary node (SN).

It should be noted that a service area may be denoted as cell, beam, beam group or similar to define an area of radio coverage. It should further be noted that the first and second cell may be provided by different or the same first network node 12.

Embodiments herein focus on the following questions:

If the MN is allowed to fetch the RA report from the UE:
a. How does the MN become aware of the UE's possibility to report the SN related RA information as there is no explicit RA report capability from the UE side?
b. When does the MN request the UE to report the RA reports associated to the SCG?
c. How does the UE know that the request for reporting RA Report is associated to the SCG related RA reports?

Thus, embodiments herein enable the reporting of the UE stored measurements like RAReport and/or MHI associated to the SCG to the MN, by providing a solution including one or more of the following embodiments:
1) The UE includes a capability indication to the MN that the UE is capable of reporting the SCG related RA report.
2) The UE includes a capability indication to the MN that the UE is capable of reporting the PSCell related MHI.
3) The UE includes a first indication to the MN that the UE has the SCG related RA report.
4) The UE includes a first indication to the MN that the UE has the PSCell related MHI.
5) The MN includes a second indication to the UE to report the SCG related RA report.
6) The MN includes a second indication to the UE to report the PSCell related MHI.
7) The MN central unit (CU)-control plane (CP) receives a second indication from the SN CU-CP to fetch the SCG related RA report.
8) The MN CU-CP receives a second indication from the SN CU-CP to fetch the PSCell related MHI.
9) The MN CU-CP forwarding the received reports from the UE to only the current SN CU-CP and then the SN CU-CP forwarding the received reports to the respective CU-CPs' related identifiers included in the received report.
10) The MN CU-CP forwarding the received reports from the UE to the respective CU-CPs' related identifiers included in the received report.

It should be noted that embodiments herein are applicable to both LTE and NR RAN nodes; applicable to any multi-connectivity scenarios e.g., dual connectivity scenarios such as LTE-dual connectivity (LTEDC), E-UTRA-NR Dual Connectivity (EN-DC) ( ), NR-DC, NR-E-UTRA Dual Connectivity (NE-DC), etc. Furthermore, network node and RAN node are used interchangeably. A non-limiting example of a network node or a RAN node can be an eNB, gNB, gNB-CU, gNB-CU-CP, gNB-DU.

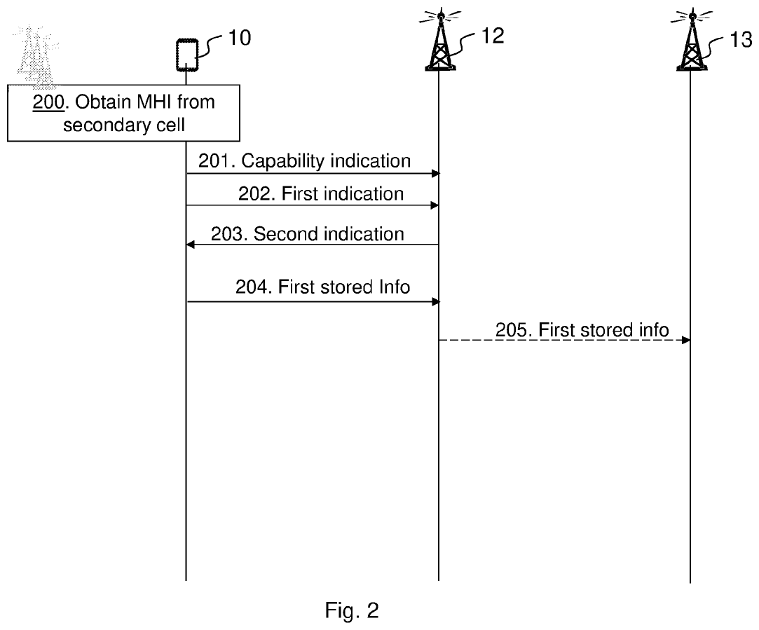

FIG. 2 is a combined flowchart and signalling scheme depicting embodiments herein.

Action 200. The UE 10 may obtain data relating to connection to cells i.e. MHI. The UE 10 may store this data or information associated to a secondary node such as the second network node 13 or secondary cell(s) (SCG, PSCell). For example, the UE 10 may obtain and store, for example, sequentially, a cell identifier of the secondary cells for this UE 10 and may also store the information related to how long the UE 10 has stayed in this secondary cell. The UE 10 may further keep such a history for one or more secondary cells. The UE 10 may also include information related to how long it has been out of coverage as well.

Action 201. The UE 10 indicates to the first network node 12, a capability of reporting a first stored information associated with one or more secondary nodes and/or secondary cells.

Action 202. The UE 10 may optionally send a first indication, e.g. SCGRAReportAvail or PSCellMHIRequestAvail, to the first network node 12 wherein the first indication indicates the availability of a first stored information associated to one or more secondary cells.

Action 203. The first network node 12 transmits a second indication, e.g., a request such as an SCGRAReportRequest or a PSCellMHIRequest, to the UE 10 wherein the second indication indicates the UE 10 to report the first stored information, e.g. an SCG RA report or PSCell MHI.

Action 204. The UE 10 then transmits the first stored information to the first network node 12.

Action 205. The first network node 12 may then transmit the complete or parts of the received first stored information to the second network node 13 or another network node.

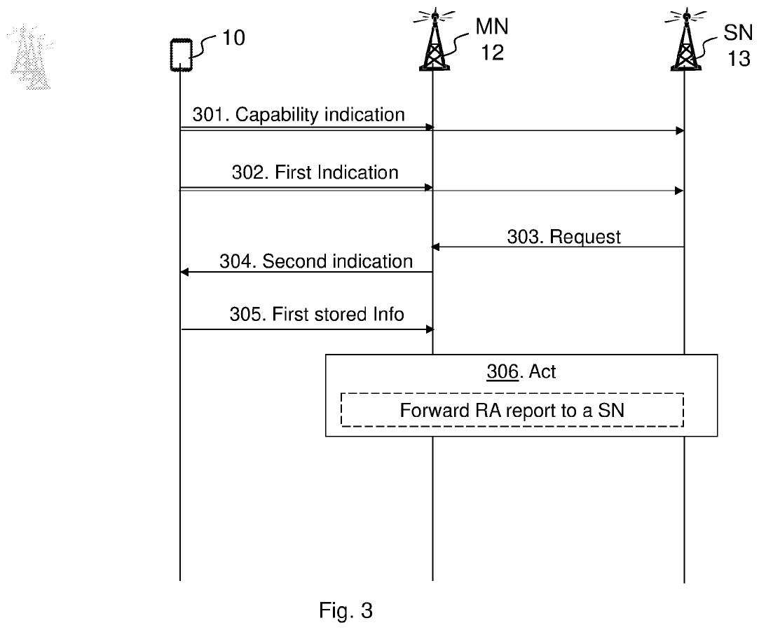

It is herein further disclosed a method by that may comprise one or more of the following actions performed by the first network node 12, the second network node 13 and/or the UE 10. The method is enabling to fetch at least a part of the first stored information such as at least a part of UE's MHI as shown in FIG. 3. Added parts in the specification text are underlined below.

Action 301. The UE 10 may indicate to one or more network nodes with a capability indication that the UE 10 is capable of reporting stored information associated with one or more secondary cells or nodes. The UE 10 may, for example, send a UE capability indication associated to storing the information associated to SCG and thereby indicating capability of reporting the stored information. In some embodiments, the UE 10 includes an explicit capability indication to the first network node 12 that it is capable of reporting the SCG related stored information. Such a capability indication may be of fine granular nature i.e., there may be separate capability indication related to the ability to report SCG related RA report and separate capability indication related to the ability to report the PSCell related MHI. The capability may be further separated in terms of the RAT type of the SCG, for example, the capability indication related to the ability to report SCG related RA report may be further separated into LTE related SCG RA reporting capability and NR related SCG RA reporting capability.

In some embodiments, the UE 10 includes an explicit capability indication to the second network node 13 that it is capable of reporting the SCG related stored information. Such a capability indication may be of fine granular nature i.e., there may be separate capability indication related to the ability to report SCG related RA report and separate capability indication related to the ability to report the PSCell related MHI. The capability may be further separated in terms of the RAT type of the SCG, for example, the capability indication related to the ability to report SCG related RA report may be further separated into LTE related SCG RA reporting capability and NR related SCG RA reporting capability.

Action 302. The UE 10 may transmit the first indication to the first network node 12 or the second network node 13 wherein the first indication indicates the availability of the first stored information associated to one or more secondary cells. The first indication may be denoted as UE stored information associated to SCG related availability indication.

In some embodiments, the UE 10 includes an explicit indication to the first network node 12 about the availability of a stored SCG related information. If the UE 10 has stored RA reports associated to the SCG, then the UE 10 may include a flag, e.g. an scgRAReportAvail, in one or more RRC messages, e.g. one or more of an RRCSetupComplete, RRCResumeComplete, RRCReconfigurationComplete, RRCReestablishmentComplete and UEInformationResponse, sent to the first network node 12. If the UE 10 has stored a PSCell MHI, then the UE 10 may include a flag, e.g. a psCellMHIAvail, in the RRC messages, e.g. one or more of an RRCSetupComplete, RRCResumeComplete, RRCReconfigurationComplete, RRCReestablishmentComplete and UEInformationResponse, sent to the first network node 12.

An example implementation is given below (in the example, RRCSetupComplete message is used but this is just one example message).

| RRCSetupComplete-v1610-IEs : := | SEQUENCE { | |
|---|---|---|
| iab-NodeIndication-r16 | ENUMERATED {true} | OPTIONAL, |
| idleMeasAvailable-r16 | ENUMERATED {true} | OPTIONAL, |
| ue-MeasurementsAvailable-r16 | UE-MeasurementsAvailable-r16 OPTIONAL, | |
| mobilityHistoryAvail-r16 | ENUMERATED {true} | OPTIONAL, |

```
  mobilityState-r16 ENUMERATED {normal, medium, high, spare} OPTIONAL,
  scgRAReportAvail  ENUMERATED {true}  OPTIONAL,
  psCellMHIAvail  ENUMERATED {true}  OPTIONAL,
```

| | | |
|---|---|---|
| nonCriticalExtension | SEQUENCE { } | OPTIONAL |

}

RRCSetupComplete-IEs field descriptions
guami-Type
This field is used to indicate whether the GUAMI included is native (derived from native 5G-GUTI) or mapped (from
EPS, derived from EPS GUTI) as specified in TS 24.501 [23].
iab-NodeIndication
This field is used to indicate that the connection is being established by an IAB-node as specified in TS 38.300 [2].
idleMeasAvailable
Indication that the UE has idle/inactive measurement report available.
mobilityState
This field indicates the UE mobility state (as defined in TS 38.304 [20], clause 5.2.4.3) just prior to UE going into
RRC_CONNECTED state. The UE indicates the value of medium and high when being in Medium-mobility and
High-mobility states respectively. Otherwise the UE indicates the value normal.
ng-5G-S-TMSI-Part2
The leftmost 9 bits of 5G-S-TMSI.
psCellMHIAvail
This field indicates that the UE has MHI associated to PSCell available.
registeredAMF
This field is used to transfer the GUAMI of the AMF where the UE is registered, as provided by upper layers, see
TS 23.003 [21].
scqReportAvail
This field indicates that the UE has SCG related RA reports available.
selectedPLMN-Identity
Index of the PLMN or SNPN selected by the UE from the plmn-IdentityList or npn-IdentityInfoList fields included in
SIB1.

In some embodiments, the UE 10 includes an explicit indication to the second network node 13 about the availability of a stored SCG related information. If the UE 10 has stored RA reports associated to the SCG, then the UE 10 may include a flag, e.g. an scgRAReportAvail, in the RRC messages, e.g. one or more of an RRCReconfigurationComplete and UEInformationResponse, sent to the second network node 13. If the UE 10 has stored PSCell MHI, then the UE 10 may include a flag, e.g. a psCellMHIAvail, in the RRC messages, e.g. one or more of an RRCReconfigurationComplete and UEInformationResponse, sent to the second network node 13.

Action 303. The second network node 13 may then request the first network node 12 to fetch the available first stored information relating to secondary nodes and/or second cell(s). For example, a SN CU-CP may request MN CU-CP to fetch the SN/SCG related information stored by the UE 10. Hence, the SN CU-CP may request the MN CU-CP to fetch the UE stored information associated to the SN. This may be performed via inter-node messages or via inter-node signaling.

| CG-Config-v1560-IEs : := | SEQUENCE { | |
|---|---|---|
| PSCellFrequencyEUTRA | ARFCN-ValueEUTRA | OPTIONAL, |
| scg-CellGroupConfigEUTRA | OCTET STRING | OPTIONAL, |
| candidateCellInfoListSN-EUTRA | OCTET STRING | OPTIONAL, |
| candidateServingFreqListEUTRA | CandidateServingFreqListEUTRA OPTIONAL, | |
| needForGaps | ENUMERATED {true} | OPTIONAL, |
| drx-ConfigSCG | DRX-Config | OPTIONAL, |
| reportCGI-RequestEUTRA | SEQUENCE { | |
| requestedCellInfoEUTRA | SEQUENCE { | |
| eutraFrequency | | ARFCN-ValueEUTRA, |

| | |
|---|---|
| cellForWhichToReportCGI-EUTRA | EUTRA-PhysCellId |
| } | OPTIONAL |
| } | OPTIONAL, |

```
  scgRAReportFetchRequest ENUMERATED {true} OPTIONAL,
  psCellMHIFetchRequest ENUMERATED {true} OPTIONAL,
```

| | |
|---|---|
| nonCriticalExtension | CG-Config-v1590-IEs OPTIONAL |
| } | |

CG-Config field descriptions
scgRAReportFetchRequest
Indicates the request to fetch the SCG related RA reports
stored by the UE.
psCellMHIFetchRequest
Indicates the request to fetch the PSCell related MHI
reports stored by the UE.

Action 304. The first network node 12 may request, using the second indication, the UE 10 to transmit available first stored information associated to the one or more secondary cells. This may be triggered by the received first indication from the UE 10 or from the request from the second network node 13.

For example, the first network node 12 may request for fetching the stored information associated to SCG.

In some embodiments, the first network node 12 explicitly includes an indication to the UE 10 that it is interested in collecting the SCG related information stored by the UE 10. If the first network node 12 wants to fetch the SCG related RA reports, then the first network node 12 may explicitly indicate that it wants the UE 10 to report SCG related RA reports via a flag, e.g. an scgRA-ReportReq, in the UEInformationRequest message or any other RRC messages. If the first network node 12 wants to fetch the PSCell related MHI, then the first network node 12 may explicitly indicate that it wants the UE 10 to report PSCell MHI via a flag, e.g. a psCellMHIReq, in the UEInformationRequest message or any other RRC messages. An example implementation is given below.

UEInformationRequest-r16-IEs : := SEQUENCE {

| | | |
|---|---|---|
| idleModeMeasurementReq-r16 | ENUMERATED{true} | OPTIONAL, -- Need N |
| logMeasReportReq-r16 | ENUMERATED {true} | OPTIONAL, -- Need N |
| connEstFailReportReq-r16 | ENUMERATED {true} | OPTIONAL, -- Need N |
| ra-ReportReq-r16 | ENUMERATED {true} | OPTIONAL, -- Need N |
| rlf-ReportReq-r16 | ENUMERATED {true} | OPTIONAL, -- Need N |

| | |
|---|---|
| mobilityHistoryReportReq-r16 | ENUMERATED {true}OPTIONAL, -- Need N |

```
  scgRA-ReportReq-r16 ENUMERATED {true} OPTIONAL, -- Need N
  psCellMHIReq-r16 ENUMERATED {true} OPTIONAL, -- Need N
```

| | | |
|---|---|---|
| lateNonCriticalExtension | OCTET STRING | OPTIONAL, |
| nonCriticalExtension | SEQUENCE { } | OPTIONAL, |
| } | | |

-- TAG-UEINFORMATIONREQUEST-STOP
-- ASN1STOP

UEInformationRequest-IEs field descriptions
connEstFailReportReq
This field is used to indicate whether the UE shall report information about the connection failure.
idleModeMeasurementReq
This field indicates that the UE shall report the idle/inactive measurement information, if available,
to the network in the UEInformationResponse message.
logMeasReportReq
This field is used to indicate whether the UE shall report information about logged measurements.
mobilityHistoryReportReq
This field is used to indicate whether the UE shall report information about mobility history information.
psCellMHIReportReq
This field is used to indicate whether the UE shall report information about the PSCell mobility
history information.
ra-ReportReq
This field is used to indicate whether the UE shall report information about the random access procedure.
rlf-ReportReq
This field is used to indicate whether the UE shall report information about the radio link failure.
scgRA-ReportReq
This field is used to indicate whether the UE shall report information about the SCG
related random access procedure.

Action 305. The UE 10 may then transmit the available first stored information, e.g., MHI, associated with one or more secondary cells. For example, the UE 10 may report of the stored information associated to SCG. Hence the UE 10 may, based on the received request from the network, include the requested information in the UEInformationResponse message. This information may be provided to the first network node 12 or the second network node 13.

Action 306. The first network node 12 may then act upon receiving the first stored information. For example, the first network node 12 acts upon receiving the SCG related UE stored information and may comprise one or more of the following:

In some embodiments, the first network node 12 upon receiving, for example, RA reports or MHI, i.e., being examples of the first stored information, from the UE 10 associated to the SCG, the MN forwards the RA reports or the MHI to the current SN of the UE 10.

In some embodiments, the first network node 12, upon receiving the RA reports or MHI from the UE 10 associated to the SCG, may check the cell identities associated to the RA reports or MHI. The first network node 12 may then forward the corresponding RA reports or MHI to each of those respective cell identities. For example, if the first network node 12 receives the RA reports associated to cell-B and cell-C, then the first network node 12 forwards the RA report of cell-B to cell-B and the RA report of cell-C to cell-C.

Alternatively, or additionally, the second network node 13 may act upon receiving the first stored information. The second network node 13 may receive the first stored information from the UE 10 or from the first network node 12. In some embodiments, the second network node 13 upon receiving the RA reports from the UE 10 associated to the SCG, the second network node 13 checks the cell identities associated to the RA reports included in the received message and forwards the corresponding RA reports to each of those respective cell identities. For example, if the second network node 13 receives the RA reports associated to cell-B and cell-C, then the second network node 13 may forward the RA report of cell-B to cell-B and the RA report of cell-C to cell-C.

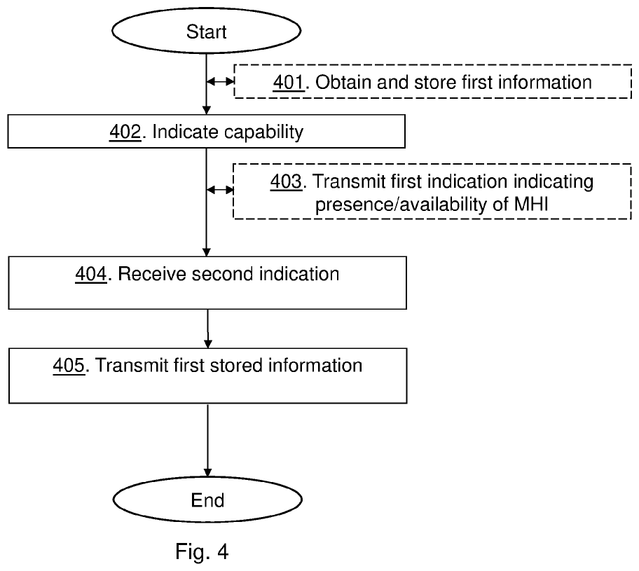

Actions performed by the UE 10 for handling communication in the wireless communication network 1 according to embodiments herein will now be described with reference to a flowchart depicted in FIG. 4. The actions do not have to be taken in the order stated below, but may be taken in any suitable order. Actions performed in some embodiments are marked with dashed boxes.

Action 401. The UE 10 may obtain and store first information associated with one or more secondary nodes or secondary cells, wherein the first stored information comprises mobility history information at the UE 10. The UE 10 may for example, collect MHI and store the MHI of secondary cells. The first stored information may comprise mobility history information at the UE 10, such as measurement reports and connection related information.

Action 402. The UE 10 indicates to the first network node 12 or the second network node 13, capability of reporting first stored information associated with the one or more secondary nodes and/or secondary cells. Thus, the UE 10 may indicate capability of reporting first stored information by transmitting the capability indication that the UE 10 is capable of reporting secondary cell(s) or node(s). This corresponds to action 301 in FIG. 3.

Action 403. The UE 10 may transmit to the first network node 12 or the second network node 13, a first indication that the UE 10 has available first stored information associated with the one or more secondary nodes and/or secondary cells. Thus, the first indication may indicate presence or availability of mobility history information of the one or more secondary nodes and/or one or more primary secondary cells at the UE, e.g., availability of a report of mobility history information of SN or PSCell(s). This first indication may be transmitted to the first network node 12 or the second network node 13. This corresponds to action 302 in FIG. 3.

Action 404. The UE 10 further receives a second indication from the first network node 12 or the second network node 13, indicating a request to fetch the first stored information associated with the one or more secondary nodes and/or secondary cells.

Action 405. The UE 10 then transmits an indication of the first stored information, or the first stored information. The indication, or the first stored information, may be transmitted to the first network node 12 or the second network node 13. This corresponds to action 305 in FIG. 3. The indication of the first stored information may comprise a value, a flag or an index pointing to or indicating a certain MHI.

Thus, an exemplary embodiment covers a method performed by the UE 10 in RRC CONNECTED mode, to enable the reporting of information stored at the UE and associated to the second network node (SCG, PSCell) to the first network node 12 such as a MN. The UE 10 indicates the capability to report first stored information and the UE 10 may send a first indication, e.g., an SCGRAReportAvail or PSCellMHIRequestAvail, to the first network node 12, wherein the first indication indicates the availability of the first stored information associated to the one or more secondary nodes or cells. The UE 10 receives a second indication, e.g., an SCGRAReportRequest or PSCellMHIRequest, from the first network node 12, wherein the second indication indicates or requests the UE 10 to report the first stored information, such as an SCG RA report or PSCell MHI. The UE 10 further sends the first stored information to the first network node 12.

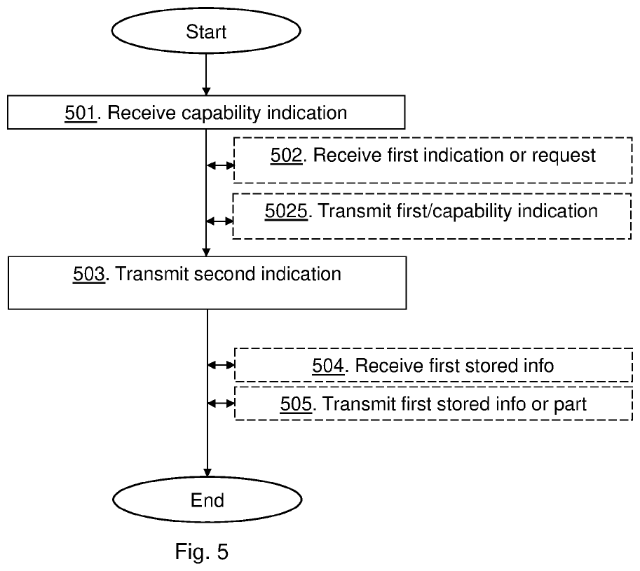

Actions performed by the first network node 12 for handling communication in the wireless communication network 1 according to embodiments herein will now be described with reference to a flowchart depicted in FIG. 5. The actions do not have to be taken in the order stated below, but may be taken in any suitable order. Actions performed in some embodiments are marked with dashed boxes.

Action 501. The first network node 12 receives a capability indication that indicates that the UE 10 is capable of reporting the first stored information associated with one or more secondary nodes and/or secondary cells.

Action 502. The first network node 12 may receive from the UE 10 a first indication that the UE 10 has available first stored information associated with the one or more secondary nodes and/or secondary cells. Alternatively, the first network node 12 may receive a request from the second network node 13 to fetch the available first stored information from the UE 10. The first indication may indicate presence or availability of mobility history information of the one or more secondary nodes and/or one or more primary secondary cells at the UE 10, e.g., availability of a report of mobility history information of SN or PSCell(s).

Action 5025. The first network node 12 may transmit to the second network node 13, the first indication that the UE 10 has available first stored information associated with the one or more secondary nodes and/or secondary cells, and/or the capability indication that the UE 10 is capable of reporting information associated with the one or more secondary nodes and/or secondary cells.

Action 503. The first network node 12 further transmits to the UE 10, the second indication indicating a request to fetch the first stored information associated with the one or more secondary nodes and/or secondary cells. This corresponds to action 304 in FIG. 3.

Action 504. The first network node 12 may then receive the indication of or the first stored information. For example, the first network node 12 may receive, from the UE 10, the indication of or the available first stored information associated with the one or more secondary nodes and/or secondary cells.

Action 505. The first network node 12 may then transmit the first stored information or a part of the first stored information to the second network node 13 or another network node. The first network node 12 may transmit complete or part of the first stored information to the second network node 13 or another network node. For example, the first network node 12, such as a MN CU-CP, may forward received SCG related RA reports or parts of SCG related RA reports from the UE 10 to only the SN CU-CP the UE 10 is currently connected to. The SN CU-CP may then forward the received SCG related RA reports to the respective CU-CPs' related identifiers included in the received SCG related RA reports. Alternatively, the MN CU-CP may forward the received SCG related RA reports from the UE 10 to the respective CU-CPs' related identifiers included in the received SCG related RA reports. This corresponds to action 306 in FIG. 3.

Thus, an exemplary embodiment covers a method performed by the first network node 12, such as a MN, to enable the reporting of a UE first stored information associated to a secondary node or cell (SCG, PSCell). The first network node 12 receives the capability indication, and may receive the first indication, such as the SCGRAReportAvail or PSCellMHIRequestAvail, from the UE 10, wherein the first indication indicates the availability of the first stored information associated to the secondary node or secondary cell. The first network node 12 may further receive a third indication, i.e., the request, such as an SCGRAReportFetchRequest or PSCellMHIFetchRequest, from the second network node 13, wherein the third indication indicates the first network node 12 to fetch the first stored information from the UE 10. The first network node 12 transmits to the UE 10, the second indication indicating a request to fetch the first stored information. The first network node 12 may then receive the first stored information from the UE 10, and may send the complete or parts of the received first stored information to the second network node 13 and/or to a third network node. This may be the case when information regarding the third network node is included in the received first stored information.

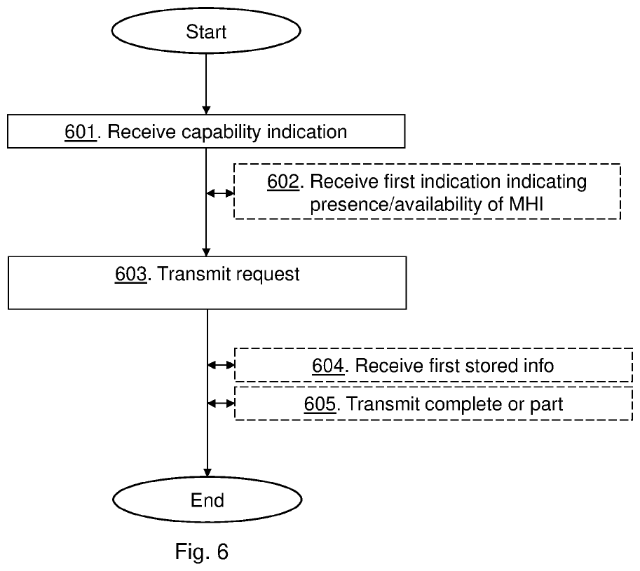

Actions performed by the second network node 13 for handling communication in the wireless communication network 1 according to embodiments herein will now be described with reference to a flowchart depicted in FIG. 6. The actions do not have to be taken in the order stated below, but may be taken in any suitable order. Actions performed in some embodiments are marked with dashed boxes.

Action 601. The second network node 13 receives from the first network node 12 or the UE 10, the capability indication that the UE 10 is capable of reporting the first stored information associated with one or more secondary nodes and/or secondary cells

Action 602. The second network node 13 may, optionally, receive from the UE 10 or from the first network node 12, a first indication that the UE 10 has available first stored information associated with the one or more secondary nodes and/or secondary cells. The first indication may indicate presence or availability of mobility history information of the one or more secondary nodes and/or one or more primary secondary cells at the UE, e.g., availability of a report of mobility history information of SN or PSCell(s).

Action 603. The second network node 13 further transmits a second indication to the UE 10 or to the first network node 12 indicating the request to fetch first stored information associated with the one or more secondary nodes and/or secondary cells, see Action 303 in FIG. 3.

Action 604. The second network node 13 may then receive, from the UE 10 or from the first network node 12, an indication of the first stored information or first stored information or a part of the first stored information.

Action 605. The second network node 13 may then transmit the first stored information or a part of the first stored information to another network node.

Thus, an exemplary embodiment covers a method performed by the second network node, such as a SN, to enable the reporting of information associated to a secondary node or cell (SCG, PSCell). The information is stored at the UE 10. The second network node 13 receives the capability indication that the UE is capable of reporting first stored information, and may receive the first indication, such as the SCGRAReportAvail or PSCellMHIRequestAvail, from the UE 10, wherein the first indication indicates the availability of first stored information associated to the one or more secondary nodes or secondary cells. The second network node 13 may further transmit a third indication, i.e., a request, such as the SCGRAReportFetchRequest or PSCellMHIFetchRequest, to the first network node 12, wherein the third indication indicates to the first network node 12 to fetch the first stored information from the UE 10. The second network node 12 may then receive the first stored information from the UE 10 or the first network node 12, and may send the complete or parts of the received first stored information to the third network node. This may be the case when information regarding the third network node is included in the received first stored information.

Embodiments herein provides methods that enable the network to fetch the mobility history information for a certain number of secondary cells.

The explanation is provided with NR node related examples but it should be noted that it is relevant to any RAT wherein the dual connectivity can be enabled, e.g., LTE.

The explanation is given for the first information such as SCG related RA report and PSCell related MHI but is not restricted to these UE stored SN/SCG related measurements.

Information flow possibilities the first network node 12 is denoted as MN and the second network node 13 is denoted as SN:
1) MN receiving inputs from the UE 10 about the availability
   a. MN initiating the fetching of the reports from the UE 10
      i. MN forwarding the fetched report to the current SN
         In this scenario, MN gets a notification from the UE 10 that the UE 10 has SCG related information to be reported. MN fetches these reports from the UE 10 and then MN forwards the fetched information to the SN.
      ii. MN forwarding the fetched report to the past SNs.
         In this scenario, MN gets a notification from the UE 10 that the UE has SCG related information to be reported. MN fetches these reports from the UE 10 and then MN forwards to each of the cell identifiers included in the fetched information.
   b. SN initiating the fetching of the reports from the UE 10
      i. SN forwarding the fetched report to the past SNs
         In this scenario, MN gets a notification from the UE 10 that the UE 10 has SCG related information to be reported. MN forwards this information to the SN. SN fetches these reports from the UE 10 and then SN forwards to each of the cell identifiers included in the fetched information.
2) SN receiving inputs from the UE 10 about the availability
   a. MN initiating the fetching of the reports from the UE 10
      i. MN forwarding the fetched report to the current SN
         In this scenario, SN gets a notification from the UE 10 that the UE 10 has SCG related information to be reported. SN then requests the MN to fetch these reports from the UE 10. MN fetches these reports from the UE 10 and then MN forwards the fetched information to the current SN.
      ii. MN forwarding the fetched report to the past SNs
         In this scenario, SN gets a notification from the UE 10 that the UE 10 has SCG related information to be reported. SN then requests the MN to fetch these reports from the UE 10. MN fetches these reports from the UE 10 and then MN forwards to each of the cell identifiers included in the fetched information.
   b. SN initiating the fetching of the reports from the UE 10
      i. SN forwarding the fetched report to the past SNs
         In this scenario, SN gets a notification from the UE 10 that the UE 10 has SCG related information to be reported. SN fetches these reports from the UE 10 and then SN forwards to each of the cell identifiers included in the fetched information.
3) SN indicating to the MN about the availability of information at the UE 10.
   a. MN initiating the fetching of the reports from the UE 10
      i. MN forwarding the fetched report to the current SN
         In this scenario, SN gets to know about the availability of UE's stored information (e.g., a notification from the SN-DU that the UE 10 has performed a RA procedure). SN then requests the MN to fetch these reports from the UE 10. MN fetches these reports from the UE 10 and then MN forwards the fetched information to the current SN.
      ii. MN forwarding the fetched report to the past SNs
         In this scenario, SN gets to know about the availability of UE's stored information (e.g., a notification from the SN-DU that the UE 10 has performed a RA procedure). SN then requests the MN to fetch these reports from the UE 10. MN fetches these reports from the UE 10 and then MN forwards to each of the cell identifiers included in the fetched information.

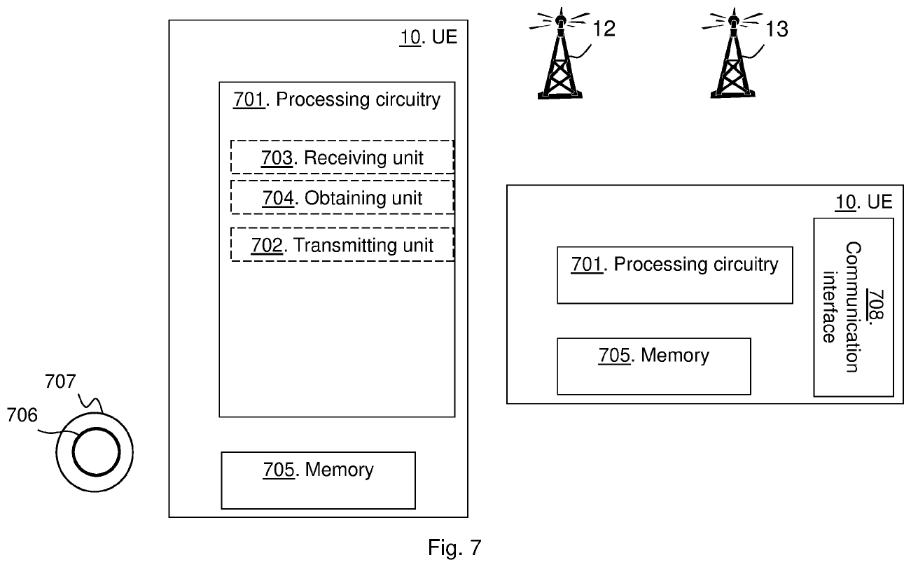

FIG. 7 is a block diagram depicting the UE 10, in two embodiments, for handling communication, e.g., handling, enabling UE reporting, in the wireless communication network 1 according to embodiments herein.

The UE 10 may comprise processing circuitry 701, e.g. one or more processors, configured to perform the methods herein.

The UE 10 may comprise a transmitting unit 702, e.g. a transmitter or transceiver. The UE 10, the processing circuitry 701 and/or the transmitting unit 702 is configured to indicate to the first network node 12 or the second network node 13, the capability of reporting the first stored information associated with one or more secondary nodes and/or secondary cells. The UE 10, the processing circuitry 701 and/or the transmitting unit 702 may be configured to transmit the first indication that the UE 10 has available first stored information associated with one or more secondary node and/or secondary cells. Thus, the first indication may indicate presence or availability of mobility history information of the one or more secondary nodes and/or one or more primary secondary cells at the UE e.g. availability of a report of mobility history information of SN or PSCell(s). This first indication may be transmitted to the first network node 12 or the second network node 13. The UE 10, the processing circuitry 701 and/or the transmitting unit 702 may be configured to indicate the capability of reporting first stored information by transmitting the capability indication that the UE is capable of reporting secondary cell or nodes.

The UE 10 may comprise a receiving unit 703, e.g. a receiver or transceiver. The UE 10, the processing circuitry 701 and/or the receiving unit 703 is configured to receive the second indication from the first network node 12 or the second network node 13, indicating the request to fetch the available first stored information associated with the one or more secondary nodes and/or secondary cells.

The UE 10 may comprise an obtaining unit 704. The UE 10, the processing circuitry 701 and/or the collecting unit 704 may be configured to obtain and stored the first information associated with the one or more secondary nodes or secondary cells, wherein the first stored information comprises mobility history information at the UE 10. The UE 10, the processing circuitry 701 and/or the collecting unit 704 may be configured to obtain and store first information associated with one or more secondary nodes or cells. The first stored information may comprise mobility history information at the UE 10, such as measurement reports and connection related information.

The UE 10, the processing circuitry 701 and/or the transmitting unit 702 is configured to transmit the indication of the first stored information, or the first stored information. The indication or the first stored information may be transmitted to the first network node 12 or the second network node 13. Thus, a response indication comprising the mobility history information of the node or cell(s).

The UE 10 further comprises a memory 705. The memory comprises one or more units to be used to store data on, such as indications, strengths or qualities, indications, MHI, grants, messages, execution conditions, user data, reconfiguration, configurations, scheduling information, timers, applications to perform the methods disclosed herein when being executed, and similar. The UE 10 comprises a communication interface 708 comprising transmitter, receiver, transceiver and/or one or more antennas. Thus, embodiments herein may disclose a UE for handling communication in a wireless communications network, wherein the UE comprises processing circuitry and a memory, said memory comprising instructions executable by said processing circuitry whereby said UE is operative to perform any of the methods herein.

The methods according to the embodiments described herein for the UE 10 are respectively implemented by means of e.g. a computer program product 706 or a computer program product, comprising instructions, i.e., software code portions, which, when executed on at least one processor, cause the at least one processor to carry out the actions described herein, as performed by the UE 10. The computer program product 706 may be stored on a computer-readable storage medium 707, e.g. a universal serial bus (USB) stick, a disc or similar. The computer-readable storage medium 707, having stored thereon the computer program product, may comprise the instructions which, when executed on at least one processor, cause the at least one processor to carry out the actions described herein, as performed by the UE 10. In some embodiments, the computer-readable storage medium may be a non-transitory or transitory computer-readable storage medium.

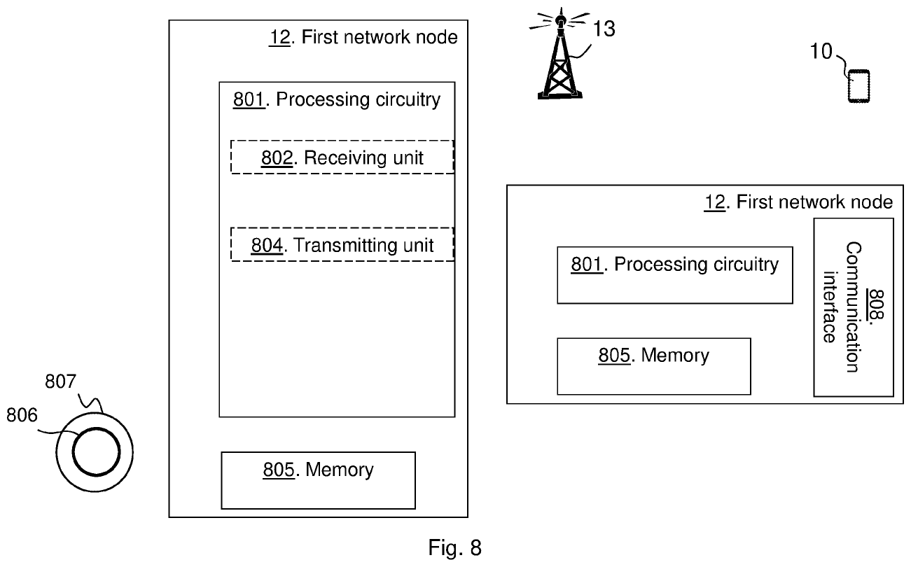

FIG. 8 is a block diagram depicting the first network node 12, in two embodiments, for handling communication, e.g. handling, enabling UE reporting, in the wireless communication network 1 according to embodiments herein.

The first network node 12 may comprise processing circuitry 801, e.g. one or more processors, configured to perform the methods herein.

The first network node 12 may comprise a receiving unit 802, e.g. a receiver or transceiver. The first network node 12, the processing circuitry 801 and/or the receiving unit 802 is configured to receive the capability indication that the UE 10 is capable of reporting the first stored information associated with the one or more secondary nodes and/or secondary cells. The first network node 12, the processing circuitry 801 and/or the receiving unit 802 may be configured to receive from the UE 10 the first indication that the UE has available first stored information associated with one or more secondary node and/or secondary cells; or the request from second network node 13 to retrieve or fetch the first stored information from the UE 10. The first indication may indicate presence or availability of mobility history information the one or more secondary nodes and/or one or more primary secondary cells at the UE e.g. availability of a report of mobility history information of SN or PSCell(s).

The first network node 12 may comprise a transmitting unit 804, e.g. a transmitter or transceiver. The first network node 12, the processing circuitry 801 and/or the transmitting unit 804 is configured to transmit the second indication to the UE 10 indicating the request to fetch the first stored information associated with the one or more secondary nodes and/or secondary cells. The first network node 12, the processing circuitry 801 and/or the transmitting unit 804 may be configured to transmit to the second network node 13, the first indication that the UE 10 has available first stored information associated with the one or more secondary node and/or secondary cells, and/or the capability indication that the UE 10 is capable of reporting information associated with the one or more secondary nodes and/or secondary cells.

The first network node 12, the processing circuitry 801 and/or the receiving unit 802 may be configured to receive, from the UE 10, the indication of or the available first stored information.

The first network node 12, the processing circuitry 801 and/or the transmitting unit 804 may be configured to transmit the first stored information, i.e., complete, or part of the first stored information to the second network node 13 or another network node.

The first network node 12 further comprises a memory 805. The memory comprises one or more units to be used to store data on, such as indications, strengths or qualities, indications, MHI, grants, messages, execution conditions, user data, reconfiguration, configurations, scheduling information, timers, applications to perform the methods disclosed herein when being executed, and similar. The first network node 12 comprises a communication interface 808 comprising transmitter, receiver, transceiver and/or one or more antennas. Thus, embodiments herein may disclose a first network node for handling communication in a wireless communications network, wherein the first network node comprises processing circuitry and a memory, said memory comprising instructions executable by said processing circuitry whereby said first network node is operative to perform any of the methods herein.

The methods according to the embodiments described herein for the first network node 12 are respectively implemented by means of e.g. a computer program product 806 or a computer program product, comprising instructions, i.e., software code portions, which, when executed on at least one processor, cause the at least one processor to carry out the actions described herein, as performed by the first network node 12. The computer program product 806 may be stored on a computer-readable storage medium 807, e.g. a universal serial bus (USB) stick, a disc or similar. The computer-readable storage medium 807, having stored thereon the computer program product, may comprise the instructions which, when executed on at least one processor, cause the at least one processor to carry out the actions described herein, as performed by the first network node 12. In some embodiments, the computer-readable storage medium may be a non-transitory or transitory computer-readable storage medium.

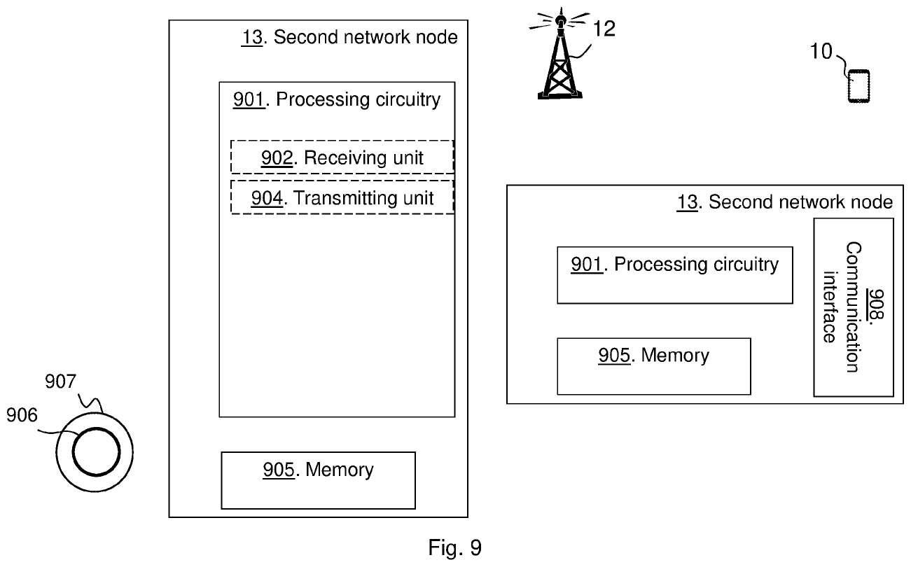

FIG. 9 is a block diagram depicting the second network node 13, in two embodiments, for handling communication, e.g. handling, enabling UE reporting, in the wireless communication network 1 according to embodiments herein.

The second network node 13 may comprise processing circuitry 901, e.g. one or more processors, configured to perform the methods herein.

The second network node 13 may comprise a receiving unit 902, e.g. a receiver or transceiver. The second network node 13, the processing circuitry 901 and/or the receiving unit 902 is configured to receive from the first network node 12 or the UE 10, the capability indication that the UE 10 is capable of reporting the first stored information associated with the one or more secondary nodes and/or secondary cells.

The second network node 13, the processing circuitry 901 and/or the receiving unit 902 may be configured to receive, from the UE 10 or from the first network node 12, the first indication that the UE 10 has available first stored information associated with the one or more secondary nodes and/or secondary cells. The first indication may indicate presence or availability of mobility history information of the one or more secondary nodes and/or one or more primary secondary cells at the UE e.g. availability of a report of mobility history information of SN or PSCell(s).

The second network node 13 may comprise a transmitting unit 904, e.g. a transmitter or transceiver. The second network node 13, the processing circuitry 901 and/or the transmitting unit 904 is configured to transmit the second indication, to the UE or to the first network node 12, indicating the request to fetch the first stored information associated with the one or more secondary nodes and/or secondary cells.

The second network node 13, the processing circuitry 901 and/or the receiving unit 902 may be configured to receive, from the UE 10 or from the first network node 12, the indication of the first stored information, the first stored information, or a part of the first stored information.

The second network node 13, the processing circuitry 901 and/or the transmitting unit 904 may be configured to transmit the first stored information or the part of the first stored information to another network node.

The second network node 13 further comprises a memory 905. The memory comprises one or more units to be used to store data on, such as indications, strengths or qualities, indications, MHI, grants, messages, execution conditions, user data, reconfiguration, configurations, scheduling information, timers, applications to perform the methods disclosed herein when being executed, and similar. The second network node 13 comprises a communication interface 908 comprising transmitter, receiver, transceiver and/or one or more antennas. Thus, embodiments herein may disclose a second network node 13 for handling communication in a wireless communications network, wherein the second network node comprises processing circuitry and a memory, said memory comprising instructions executable by said processing circuitry whereby said second network node 13 is operative to perform any of the methods herein.

The methods according to the embodiments described herein for the second network node 13 are respectively implemented by means of e.g. a computer program product 906 or a computer program product, comprising instructions, i.e., software code portions, which, when executed on at least one processor, cause the at least one processor to carry out the actions described herein, as performed by the second network node 13. The computer program product 906 may be stored on a computer-readable storage medium 907, e.g. a universal serial bus (USB) stick, a disc or similar. The computer-readable storage medium 907, having stored thereon the computer program product, may comprise the instructions which, when executed on at least one processor, cause the at least one processor to carry out the actions described herein, as performed by the second network node 13. In some embodiments, the computer-readable storage medium may be a non-transitory or transitory computer-readable storage medium.

In some embodiments a more general term “radio network node” or “network node” is interchangeably used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

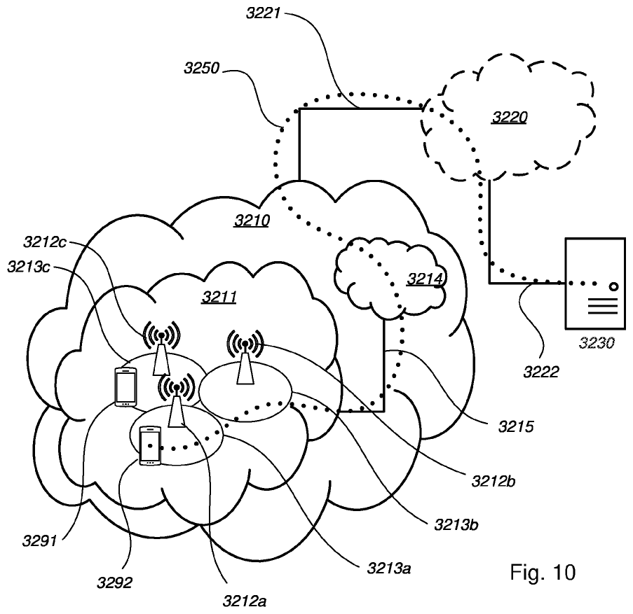

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the network nodes 12 and 13 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

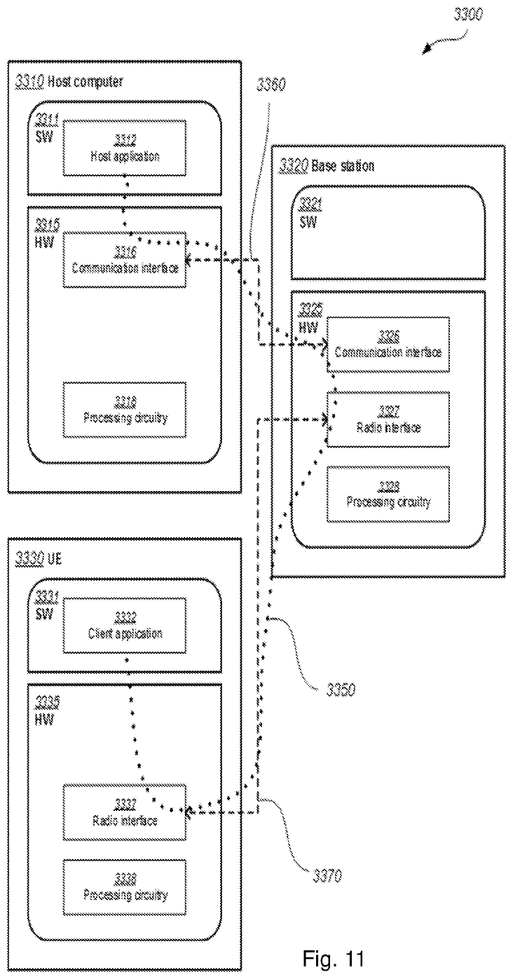

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may achieve an efficient and accurate MHI reporting and thereby provide benefits such as reduced waiting time, improved battery time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

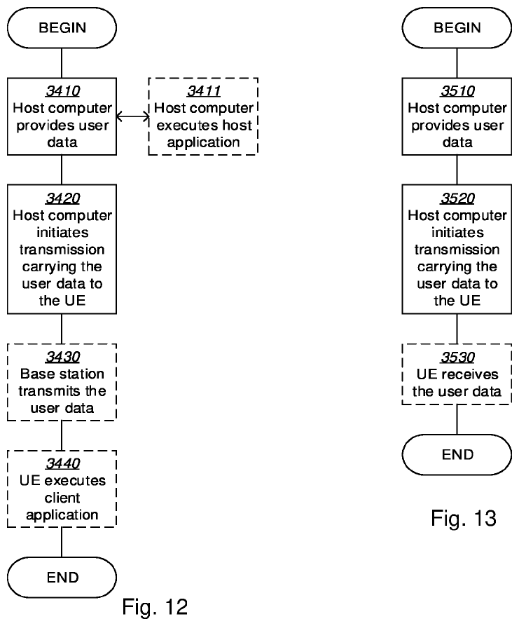

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

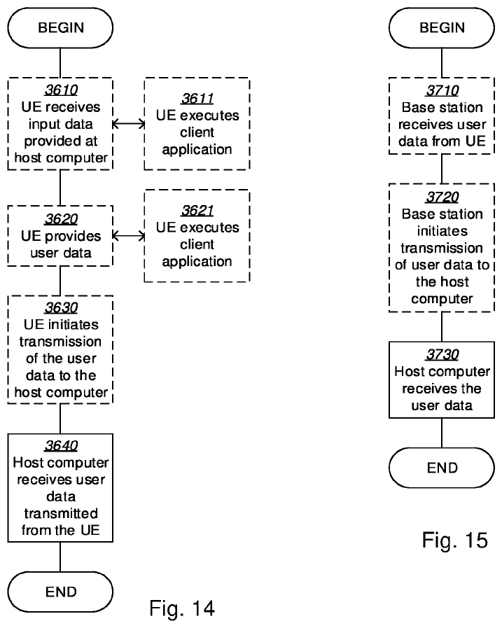

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### ABBREVIATIONS

MCG Master Cell group
HO Handover
CHO Conditional handover
UE User Equipment
CU central Unit
DU Distributed Unit
PCell Primary Cell
RAN Radio Access Network
RLF Radio Link Failure
HOF Handover Failure
SCG Secondary Cell Group
NW Network
SI System Information
SIB System information Block

1.-34. (canceled)

35. A method performed by a user equipment, UE, for handling communication in a wireless communication network, the method comprising:
obtaining and storing first information associated with one or more secondary nodes or secondary cells, wherein the first stored information comprises mobility history information associated with one or both of one or more secondary nodes and secondary cells;
indicating to a first network node operating as a master node, MN, a capability of reporting mobility history information associated with the one or both of the one or more secondary nodes and secondary cells;
receiving a second indication from the first network node, indicating a request to fetch mobility history information associated with one or both of the one or more secondary nodes and secondary cells; and
transmitting an indication of the first stored information, or the first stored information.

36. The method according to claim 35, further comprising:
transmitting to the first network node, a first indication that indicates presence or availability of mobility history information of the one or both of the one or more secondary nodes and the one or more primary secondary cells at the UE.

37. The method according to claim 35, wherein the indication of or the first stored information is transmitted to the first network node.

38. A method performed by a first network node for handling communication in a wireless communication network, the method comprising:
receiving a capability indication that a UE is capable of reporting a first stored information associated with one or both of one or more secondary nodes and secondary cells, the first stored information comprising mobility history information at the UE;
transmitting to the UE, a second indication indicating a request to fetch mobility history information associated with the one or both of the one or more secondary nodes and secondary cells; and
receiving an indication of the first stored information or the first stored information from the UE.

39. The method according to claim 38, further comprising:
receiving from the UE a first indication that indicates presence or availability of mobility history information of the one or both of the one or more secondary nodes and one or more primary secondary cells at the UE.

40. The method according to claim 39, further comprising:
transmitting to a second network node operating as a secondary node, SN, the first indication that the UE has available first stored information associated with the one or both of the one or more secondary nodes and secondary cells.

41. The method according to claim 38, further comprising:
transmitting to a second network node, operating as a secondary node, SN, the capability indication that the UE is capable of reporting mobility history information associated with the one or both of the one or more secondary nodes and secondary cells.

42. The method according to claim 38, further comprising:
receiving a request from a second network node, operating as a secondary node, SN, to fetch mobility history information associated with the one or both of the one or more secondary nodes and secondary cells from the UE.

43. The method according to claim 38, further comprising:
transmitting the first stored information or a part of the first stored information to a second network node operating as a secondary node, SN, or another network node.

44. A method performed by a second network node operating as a secondary node, SN, for handling communication in a wireless communication network, the method comprising:
receiving from a first network node, operating as a master node, MN, a capability indication that the UE is capable of reporting a first stored information associated with one or both of one or more secondary nodes and secondary cells, the first stored information comprising mobility history information associated with the one or both of the one or more secondary nodes and secondary cells; and
transmitting a second indication to the first network node, indicating a request to fetch the mobility history information associated with the one or both of the one or more secondary nodes and secondary cells.

45. The method according to claim 44, further comprising:
receiving, from the first network node, a first indication that indicates presence or availability of mobility history information of the one or both of the one or more secondary nodes and one or more primary secondary cells at the UE.

46. The method according to claim 44, further comprising:
receiving from the first network node, an indication of the first stored information, the first stored information, or a part of the first stored information.

47. The method according to claim 44, further comprising:
transmitting the first stored information or a part of the first stored information to another network node.

48. A user equipment, UE, for handling communication in a wireless communication network, the UE being configured to:
obtain and store first information associated with one or both of one or more secondary nodes or secondary cells, the first stored information comprising mobility history information associated with one or more secondary nodes and secondary cells;
indicate to a first network node operating as a master node, MN, a capability of reporting mobility history information associated with the one or both of the one or more secondary nodes and secondary cells;
receive a second indication from the first network node, indicating a request to fetch mobility history information associated with the one or both of the one or more secondary nodes and secondary cells; and
transmit an indication of the first stored information, or the first stored information.

49. The UE according to claim 48, wherein the UE is further configured to:
transmit to the first network node, a first indication that indicates presence or availability of mobility history information of the one or both of the one or more secondary nodes and the one or more primary secondary cells at the UE.

50. A first network node for handling communication in a wireless communication network, the first network node being configured to operate as master node, MN, and the first network node being further configured to:
receive a capability indication that a UE is capable of reporting first stored information associated with one or more secondary nodes and secondary cells, the first stored information comprising mobility history information associated with one or both of one or more secondary nodes and secondary cells at the UE;
transmit to the UE, a second indication indicating a request to fetch mobility history information associated with the one or both of the one or more secondary nodes and secondary cells; and
receive an indication of the first stored information or the first stored information from the UE.

51. The first network node according to claim 50, wherein the first network node is further configured to:
receive from the UE a first indication that indicates presence or availability of mobility history information of the one or both of the one or more secondary nodes and one or more primary secondary cells at the UE.

52. A second network node for handling communication in a wireless communication network, the second network node being configured to operate as a secondary node, SN, and the second network node being further configured to:
receive from a first network node operating as a master node, MN, a capability indication that the UE is capable of reporting first stored information associated with one or both of one or more secondary nodes and secondary cells, the first stored information comprising mobility history information associated with one or more secondary nodes and secondary cells; and
transmit a second indication to the first network node, indicating a request to fetch mobility history information associated with the one or both of the one or more secondary nodes and secondary cells.

53. The second network node according to claim 52, wherein the second network node is further configured to:
receive, from the first network node, a first indication that indicates presence or availability of mobility history information of the one or both of the one or more secondary nodes and one or more primary secondary cells at the UE.

54. The second network node according to claim 52, wherein the second network node is further configured to:
receive from the first network node, an indication of the first stored information, the first stored information, or a part of the first stored information.
